(19) United States
(12) Patent Application Publication
(10) Pub. No.: US 2007/0122521 A1
(43) Pub. Date: May 31, 2007

(54) Packaging Design with Thin Foil

(75) Inventors: Marc Degady, Morris Plains, NJ (US); Paul K. Bowers, Long Valley, NJ (US); James Anthony Glydon, Hackettstown, NJ (US)

Correspondence Address: MARSH, FISCHMANN & BREYFOGLE LLP, 3151 SOUTH VAUGHN WAY, SUITE 411, AURORA, CO, 80014, US

(73) Assignee: CADBURY ADAMS USA, LLC, Rye Brook, NY (US)

(21) Appl. No.: 11/469,763

(22) Filed: Sep. 1, 2006

Related U.S. Application Data
(60) Provisional application No. 60/713,873, filed on Sep. 2, 2005.

(51) Int. Cl. A23G 4/18

(52) U.S. Cl. 426/5

(57) ABSTRACT

A gum packaging design having a plastic sheet formed to create a purality of cavities that each contain a single liquid-filled gum pellet. The gum pellets are sealed and retained within each cavity by a foil layer, having a thickness of 18 microns or less. Each gum pellet can be dispensed from the package by pressing the liquid-filled gum pellet through the relatively-thin foil layer, which breaks under less force than would a thicker foil layer and significantly reduces the likelihood of cracking of the liquid-filled gum pellet.

### CROSS-REFERENCE TO RELATED APPLICATIONS

This application claims priority from U.S. Provisional Patent Application No. 60/713,873, filed on Sep. 2, 2005, entitled “Packaging Design With Thin Foil”, the contents of which are incorporated herein by reference.

### BACKGROUND

Chewing gum is currently available to consumers in a variety of different formats. These include stick gum, slab gum, pellet gum, extruded gum, and others. Stick gum may come in sizes with a length of approximately 6-7 cm, a width of approximately 1.5-2 cm, and a thickness of approximately 0.2 cm. Slab gum may come in a size of approximately 4.5 cm in length, 1.2 cm in width, and 0.3 cm in thickness. Pellet gum may come in a variety of sizes with but one example being a size of approximately 2 cm in length, 1.3-1.5 cm in width, and 0.8-1.0 cm in thickness.

A variety of types of gum packaging also exist, including certain types of packaging used predominately for one or the other of the gum formats. Pellet gum may be packaged together in a carton that can be opened to dispense one or more pellets at a time. Various other package configurations exist, but one configuration packages each pellet individually in what has come to be known as a blister pack or package. Such a package configuration may include a sheet of plastic having multiple cavities or blisters (bulged structures) that may typically be formed in an array. The gum pellets are placed into the individual blisters and a sheet of foil is attached to the plastic sheet to contain and seal the gum pellets in the individual blisters. When a user wishes to chew a pellet of gum, they can push the pellet through the foil to break the seal only for that pellet.

Such packaging is currently popular and achieves satisfactory results. It has been discovered, however, that this approach may not work for all product configurations (e.g., liquid-filled gum pellets). Such gum pellets may have an outer shell formed of chewing gum material that is formed to provide an internal pocket containing liquid material. Typically the liquid material may provide an intense taste sensation to a person when they start to chew the gum. Depending on the structure of the liquid-filled gum pellet and how the pellet is handled, it is possible for the pellet to become prematurely and unintentionally cracked or crushed. This may be a function of the thickness and hardness of the gum material, the amount of liquid contained in the pocket, and other structural characteristics. The action of pushing the pellet through the foil has been found to cause undesirable cracking and/or crushing in some liquid-filled gum pellets.

Consumers may find cracked or crushed liquid gum pellets to be less desirable, for aesthetic reasons. This may reduce consumer acceptance of or confidence in the product. In addition, cracked or crushed pellets may allow some of the liquid to escape the pellet before being placed into a person's mouth. Further, even if a pellet is not cracked or crushed, it is possible for it to become chipped, which may not be desirable. It is against this background and with a desire to improve on the prior art that a packaging design for gum and other products has been developed.

### SUMMARY

A packaged gum product includes a plurality of gum pellets, each pellet having a region of gum material and an outer shell of material that is relatively harder than the gum material, the region of gum material forming an inner void that contains liquid material, and also includes a package that contains the plurality of gum pellets, the package having a plurality of separate compartments formed as cavities therein, each of the compartments being sealed off from the exterior by a layer of foil having a thickness of 18 microns or less, to facilitate each compartment being selectably opened by pushing the liquid-filled gum pellets through the foil layer without cracking the outer shell of the liquid-filled gum pellet.

The separate compartments may be composed of a transparent material to allow the contained gum pellets to be visible from the exterior of the package. The portion of the package that defines separate compartments may be composed of a plastic material. The plastic material may be PVC.

There may be a one-to-one correspondence between the number of gum pellets in the package and the number of separate compartments formed in the package. A single sheet of foil may seal all of the compartments. The separate compartments may be formed in a single plane. The layer of foil may have a thickness of approximately 16 microns.

A method of providing gum product includes providing a plurality of gum pellets, each pellet having a region of gum material and an outer shell of material that is relatively harder than the gum material, the region of gum material forming an inner void that contains liquid material. The method further includes providing a package that contains the plurality of gum pellets, the package having a plurality of separate compartments formed as cavities therein, each of the compartments being sealed off from the exterior by a layer of foil having a thickness of 18 microns or less. The method also includes dispensing gum pellets from the package by pushing the liquid-filled gum pellets through the foil layer without cracking the outer shell of the liquid-filled gum pellet.

A method of providing gum product includes providing a plurality of gum pellets, each pellet having a region of gum material and an outer shell of material that is relatively harder than the gum material, the region of gum material forming an inner void that contains liquid material. The method further includes providing a package that contains the plurality of gum pellets, the package having a plurality of separate compartments formed as cavities therein, each of the compartments being sealed off from the exterior by a layer of foil having a thickness of 18 microns or less to facilitate the dispensing of gum pellets from the package by pushing the liquid-filled gum pellets through the foil layer without cracking the outer shell of the liquid-filled gum pellet.

Numerous additional features and advantages will become apparent to those skilled in the art upon consideration of the further description that follows.

### BRIEF DESCRIPTION OF THE FIGURES

FIG. 1 is a perspective view of a gum packaging design.

FIG. 2 is an exploded perspective view of the gum package of FIG. 1.

FIG. 3 is a cross-sectional view of a liquid-filled gum pellet used in the gum packaging design of FIG. 1.

FIG. 4 is a cross-sectional view of a portion of the gum packaging design of FIG. 1, showing one cavity therein containing a liquid-filled gum pellet.

FIG. 5 is a similar view to FIG. 4, but showing the gum pellet being forced through the foil layer in order to remove the liquid-filled gum pellet from the cavity.

### DETAILED DESCRIPTION

Reference will now be made to the accompanying drawings, which assist in illustrating the various pertinent features of the packaging design. Although the invention will now be described primarily in conjunction with gum packaging, it should be expressly understood that the invention may be applicable to other applications where multiple compartments, each for one or more removable objects, is required/desired. In this regard, the following description of a gum packaging design is presented for purposes of illustration and description. Furthermore, the description is not intended to limit the invention to the form disclosed herein. Consequently, variations and modifications commensurate with the following teachings, and skill and knowledge of the relevant art, are within the scope of the packaging design. The embodiments described herein are further intended to explain modes known of practicing the invention and to enable others skilled in the art to utilize the invention in such, or other embodiments and with various modifications required by the particular application(s) or use(s) of the packaging design.

The packaging design includes a gum-filled package 10, as shown in FIG. 1. With reference to FIG. 2, the package 10 includes a plastic sheet 12 formed to contain a plurality of gum pellets 14 therein, which are sealed in place by a foil layer or sheet 16. This type of package 10 is sometimes known within the gum industry as a blister pack.

The plastic sheet 12 is formed so that there is a relatively-planar or flat portion 20 and a plurality of bulges or cavities 22 formed therein. The cavities 20 may be formed in an array such a 3-by-3 rectangular array. The plastic sheet 12 may be composed of any of a variety of different types of plastic, such as PVC, PET, coated PVC, or styrene, or other suitable form of plastic or other suitable material.

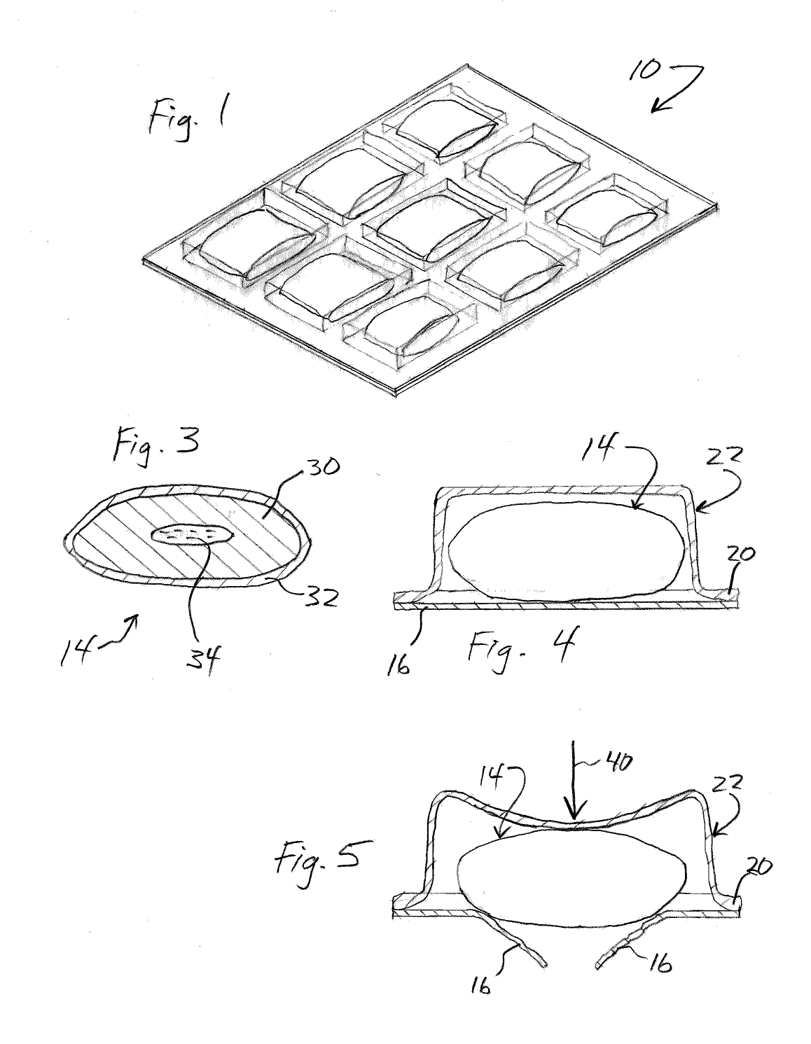

As best shown in FIG. 3, each of the gum pellets 14 include a gum region or portion 30 that is surrounded by a relatively-harder outer shell or coating 32. The gum portion may include a gum base. The outer shell 32 can be a hard coating, a soft coating, or some other suitable type of shell. The outer shell typically provides some crunchiness when initially chewed. The gum portion 30 has one or more voids defined therein to contain liquid 34. As can be appreciated, when a user places one of the gum pellets 14 into their mouth, the outer shell 32 is typically crushed by the user's teeth and as the gum portion 30 is chewed, the liquid 34 is eventually released, causing an increased flavor and/or other sensation. The pellets can be composed of most any shape including, without limitation, oval, spherical, and rectangular shapes.

Whether the pieces of formed gum material are first stored, transported in a storage container, or fed directly into a coating tunnel or mechanism, the individual pieces of gum material may subsequently be subjected to a conventional sugar or sugarless coating process in order to form a hard exterior shell on the liquid-filled gum material. Coating processes or mechanisms of this type are known. In general, the coating is applied in numerous thin layers of material in order to form an appropriate uniform coated and finished quality surface on the gum products. The hard coating material, which may include sugar, maltitol, sorbitol or any other polyol, including those described herein, and optionally flavoring, is sprayed onto the pellets of gum material as they pass through a coating mechanism or a coating tunnel and are tumbled and rotated therein. In addition, conditioned air is circulated or forced into the coating tunnel or mechanism in order to dry each of the successive coating layers on the formed products.

The coating composition may range from about 2% to about 60%, more specifically, about 20% to about 40% by weight of an individual gum piece which includes a center-fill, a gum region and a coating; even more specifically, from 25% to 35% and still more specifically around 30%. The coating may include sugar or polyol such as maltitol as the primary component, but may also include flavors, colors, etc. as described below in the discussion of the gum region.

The center-filled chewing gum provides resistance from moisture migration from the center-fill to the gum region by modifying both the polyol composition and gum base composition present in the gum region. This is in contrast to the aforementioned conventional approaches and which have not fully addressed the problems associated with manufacturing and shelf-stability of liquid center-filled products.

In some embodiments of the invention, there are included smaller piece-sizes. For example, the smallest conventional piece sizes of commercially available gum are generally in pellet forms. These piece-sizes currently range from about 5-7 grams. In some embodiments liquid filled products have been made using substantially smaller piece sizes, i.e., 50-60% smaller by weight, without loss of liquidity or migration of liquid into the gum region or beyond into the coating. Some inventive embodiments provide a liquid-filled gum piece size range which is greater than about 0.5 grams, more specifically greater than 1.5 grams up to about 3 grams, including the addition of an outer hard coating shell. In addition, in some embodiments a gum piece may include a center-fill, a gum region including a gum base and an outer coating. Such gum pieces may be about 2.2 grams total weight per piece.

It has been discovered that pieces of such small size and particularly with gum shapes or configurations having proportionally more liquid-fill surface area as compared to the weight to the liquid per se, have a greater tendency to lose the liquidity of the center due to the interaction of different factors. While not limited to a single theory, these factors include the small amount of liquid-fill in comparison to the surface of the gum region in which the liquid-fill is in direct contact, the interaction of the type of elastomer with the center-fill (i.e. SBR versus non-SBR), the compatibility of the gum region components with the liquid-fill components, and the potential capillary action of the polyol used in the gum region. For example, the structure of sorbitol, which is customarily used in gum formulations in the United States, does not provide a tightly packed crystalline structure, giving almost a sponge-like appearance. Therefore, in order to provide a center-filled gum piece of less than about 3 grams, the present invention alters the gum and gum base to include a polyol composition having a dense, tightly packed crystalline structure which is unlike the sponge-like structure in conventional sorbitol gum region formulations, in order to provide a center-filled gum piece which resists loss of liquidity.

The gum region, also referred to as the second region in the claims, provides a liquid barrier to surround and prevent the liquid-fill from migration and premature release. One or more cavities can be present in the gum region to house the liquid center-fill. The shape of the cavity will be largely dictated by the final configuration of the chewing gum piece. By selection of the ratio of the desired cavity surface area to the liquid-fill weight, optimization of the reduction in potential liquid-fill migration in to the gum region area can be achieved. This is particularly useful when the gum piece size is desired to be substantially smaller than conventional commercialized gum pieces. In particular, liquid-filled pellet gums having sizes of 2 to 3 grams by weight of the entire gum piece have been successfully made. However, smaller gum pieces, as small as about 0.5 grams are contemplated.

Some embodiments may incorporate a modified polyol composition including at least one polyol incorporated into the gum region. Moreover, the selection of a non-SBR gum base in the gum region, in combination with the modified polyol composition has been found to be particularly useful in achieving stable liquid-filled chewing gum compositions.

The gum region may include a gum base. The gum base may include any component known in the chewing gum art. For example, the gum region may include elastomers, bulking agents, waxes, elastomer solvents, emulsifiers, plasticizers, fillers and mixtures thereof. Wherein the gum region is included in a three component composition including a center-fill, a gum region and a coating layer, the gum region may comprise from about 40% to about 97%, more specifically from about 55% to about 65% by weight of the chewing gum piece, even more specifically about 62%.

The gum region may also include a specific polyol composition including at least one polyol which is from about 30% to about 80% by weight of said gum region, and specifically from 50% to about 60%. The polyol composition may include any polyol known in the art including, but not limited to maltitol, sorbitol, erythritol, xylitol, mannitol, isomalt, lactitol and combinations thereof. Lycasin™ which is a hydrogenated starch hydrolysate including sorbitol and maltitol, may also be used.

The amount of the polyol composition or combination of polyols used in the gum region will depend on many factors including the type of elastomers used in the gum base and the particular polyols used. For example, wherein the total amount of the polyol composition is in the range of about 40% to about 65% based on the weight of the gum region, the amount of maltitol may be from about 40% to about 60% in addition to an amount of sorbitol from about 0 up to about 10%, more specifically, an amount of maltitol may be from about 45% to about 55% in combination with sorbitol from about 5% to about 10%.

The amount of the gum base which is present in the gum region may also vary. The gum base may be included in the gum region in an amount from about 25% to about 45% by weight of the gum region. A more specific range of gum base is from about 28% to about 42% by weight of the gum region. Even more specifically, the range may be from about 28% to about 35% or from about 28% to about 30%.

The center-fill or liquid-fill composition may include any components known in the art for incorporation with a center-fill composition. This may include glycerine in addition to one or more other polyols in amounts greater than zero up to about 20%, more specifically, up to about 10% by weight of the total chewing gum composition, i.e., including a center-fill composition, a gum region and a coating. More desirably, the center-fill is approximately 8% by weight of the total chewing gum composition. The other polyol component includes desirably maltitol, sorbitol, xylitol, or a combination thereof.

The liquid centers may contain those traditional ingredients well known in the chewing gum and confectionery arts, such as flavoring agents, sweetening agents, and the like, and mixtures thereof, as described above. In addition to confectionery additives, the liquid centers may also contain pharmaceutical additives such as medicaments, breath fresheners, vitamins, minerals, caffeine, fruit juices, and the like, and mixtures thereof. The confectionery and pharmaceutical agents may be used in many distinct physical forms well known in the art to provide an initial burst of sweetness and flavor and/or therapeutic activity or a prolonged sensation of sweetness and flavor and/or therapeutic activity. Without being limited thereto, such physical forms include free forms, such as spray dried, powdered, and beaded forms, and encapsulated forms, and mixtures thereof. Illustrative, but not limiting, examples of liquid centers suitable for use in some embodiments include those centers disclosed in U.S. Pat. Nos. 3,894,154, 4,156,740, 4,157,402, 4,316,915, and 4,466,983, which disclosures are incorporated herein by reference. Specific examples of suitable additional components include taurine, guarana, vitamins, Actizol™, chlorophyll, Recaldent™ tooth whitening technology, and Retsyn™.

The coating composition, when included in the center-fill compositions, may be applied by any method known in the art including the method described above. The coating composition may be present in an amount from about 2% to about 60%, more specifically from about 25% to about 35% by weight of the total center-filled gum piece, even more specifically about 30% by weight of the gum piece.

The outer coating may be hard or crunchy. Typically, the outer coating may include sorbitol, maltitol, xylitol, erythritol, isomalt, and other crystallizable polyols; sucrose may also be used. Furthermore, the coating may include several opaque layers, such that the chewing gum composition is not visible through the coating itself, which can optionally be covered with a further one or more transparent layers for aesthetic, textural, and protective purposes. The outer coating may also contain small amounts of water and gum arabic. The coating can be further coated with wax. The coating may be applied in a conventional manner by successive applications of a coating solution, with drying in between each coat. As the coating dries it usually becomes opaque and is usually white, though other colorants may be added. A polyol coating can be further coated with wax. The coating can further include colored flakes or speckles. If the composition comprises a coating, it is possible that one or more oral care actives can be dispersed throughout the coating. This is especially preferred if one or more oral care actives is incompatible in a single phase composition with another of the actives. Flavors may also be added to yield unique product characteristics.

The coating may also be formulated to assist with increasing the thermal stability of the gum piece and preventing leaking of the liquid fill. In some embodiments, the coating may include a gelatin composition. The gelatin composition may be added as a 40% by weight solution and may be present in the coating composition from about 5% to about 10% by weight of the coating composition, and more specifically about 7% to about 8%. The gel strength of the gelatin may be from about 130 bloom to about 250 bloom.

Other materials may be added to the coating to achieve desired properties. These materials may include without limitations, cellulosics such as carboxymethyl cellulose, gelatin, pullulan, alginate, starch, carrageenan, xanthan gum, gum arabic, and polyvinyl acetate (PVA).

The coating composition may also include a pre-coating which is added to the individual gum pieces prior to an optional hard coating. The pre-coating may include an application of polyvinyl acetate (PVA). This may be applied as a solution of PVA in a solvent, such as ethyl alcohol. When an outer hard coating is desired, the PVA application may be approximately 3% to 4% by weight of the total coating or about 1% of the total weight of the gum piece (including a liquid-fill, gum region, and hard coating).

Additional additives, such as physiological cooling agents, throat-soothing agents, spices, warming agents, tooth-whitening agents, breath-freshening agents, vitamins minerals, caffeine, drugs, and other actives may also be included in any or all portions or regions of the chewing gum composition. Such components may be used in amounts sufficient to achieve their intended effects.

Further detail on suitable gum compositions may be found in U.S. patent application Ser. Nos. 10/925,822 and 60/650,758, which are incorporated in their entirety herein by reference.

The foil layer 16 may be composed of any suitable metal foil or other suitable material. For example, this may include medium-tempered or hard-tempered aluminum. The foil layer is 18 gauge, which means it has a thickness of 18 microns. The thickness may be thinner than 18 microns, for example 15 microns may be suitable as well. The foil is intended to provide an air seal for each of the cavities so that the gum pellets 14 are only exposed to the small amount of air within the cavity. This is done to preserve freshness of the gum pellet 14 and control the humidity to which the gum pellet 14 is exposed, since gum tends to absorb ambient moisture, and to reduce spotting or leakage of the liquid-filled gum pellet 14. The foil layer should also be commercially producible. It may be desirable for the foil 16 to not be so fragile as to be inadvertently punctured. Further, the foil layer should provide a sealing area to the plastic sheet 12 between adjacent cavities, so that when one gum-pellet is dispensed from the package 1O, adjacent gum pellets are not yet exposed to air. In addition, the foil layer 16 is sufficiently thin so that when the liquid-filled gum pellet 14 is forced through the foil layer 16, the outer shell 32 of the gum pellet 14 will not crack and liquid 34 will not leak out of the gum pellet 14. It has been discovered that the use of 18 gage or thinner foil as a foil layer 16 significantly reduces this issue.

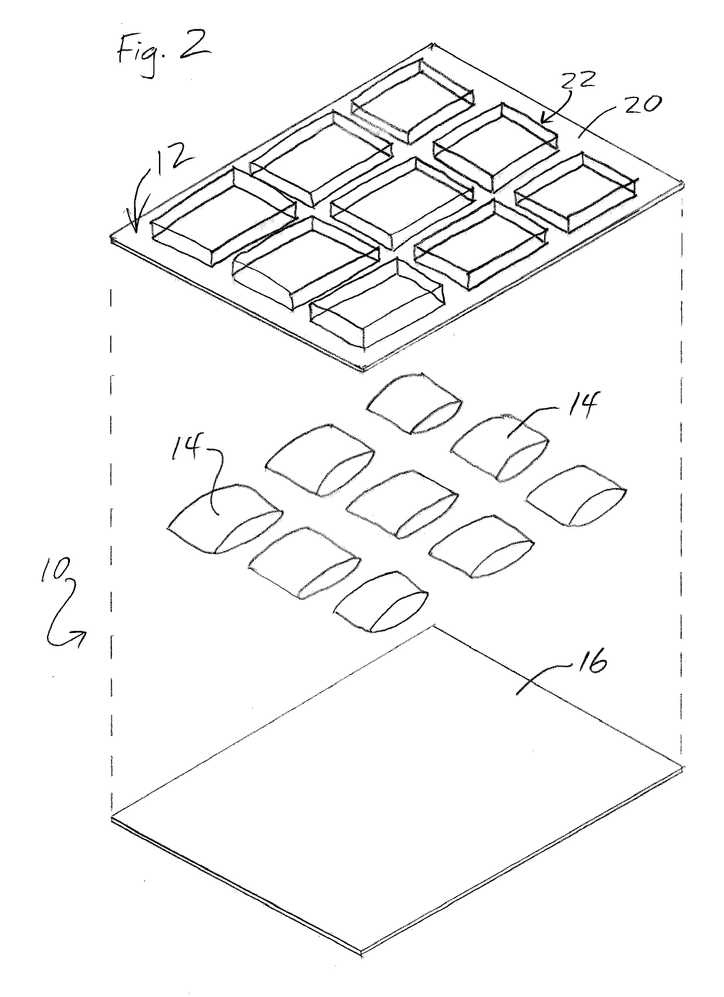

As shown in FIG. 4, each of the gum pellets 14 is retained in its separate cavity or compartment between the plastic sheet 12 and the foil layer 16 until the user dispenses it therefrom. As shown in FIG. 5, the gum pellet 14 can be dispensed from the cavity or compartment by pressing the gum pellet 14 toward the foil layer 16 in the direction of arrow 40 by deforming the top portion of the cavity formed in the plastic sheet 12 until the gum pellet 14 is displaced to a position that causes a portion of foil layer 16 in the vicinity of the cavity to rupture. Once the foil layer 16 in this vicinity has been ruptured as shown in FIG. 5, the gum pellet can be easily dispensed therefrom.

It can be appreciated that there may be many methods used for assembling the gum-filled package 10. One suitable method is described herein. The plastic sheet 12 may initially come in the form of large rolls of PVC plastic. As the PVC plastic is unrolled, it is heated to soften the plastic. Portions of the unrolled sheet of plastic are placed over a female mold in the shape of the cavities to be formed in the sheet. A vacuum is applied to these cavities to draw the softened plastic down into the mold. The vacuum is then released and the molded plastic sheet is pulled out of the mold. In parallel, the gum pellets have been prepared in a conventional fashion, and they are now deposited into the cavities formed in the plastic sheet, one gum pellet per cavity. The 18-gauge aluminum foil also comes in rolls and it is unrolled and placed adjacent to the molded sheet plastic containing the gum pellets 14. The foil is then attached to the plastic with a heating process. The foil may have one side having printed material thereon and an opposite side facing toward the plastic having a heat seal coating or lacquer that has been applied thereto by the supplier of the aluminum foil. Alternatively, an adhesive could be employed to affix the foil to the plastic. After the foil has been applied to the plastic sheet to contain the gum pellets there within, the extended sheets are cut into desired sizes such as the 3 by 3 rectangular array described above. On exemplary size of such a blister pack may be approximately 8 cm by 6.8 cm by 0.85 cm. Blisters may be placed at a pitch (distance between similar points on adjacent blisters) of 2.5 to 3 cm.

At the time this packaging design for gum was developed, the use of 18 gauge or thinner foil was not typically being used in gum packaging. The preferred thickness was 20 gauge or larger as it was more economical, since it was more commonly used and since the thicker foil was likely to puncture or inadvertently tear. It can be appreciated that by combining the use of a liquid filled gum pellet with a thinner foil, liquid-filled gum pellets can now be provided to consumers in blister packs without undesirable effects such as cracking of the outer coating and leakage of the liquid from the gum pellet.

The foregoing description of the packaging design has been presented for purposes of illustration and description. Furthermore, the description is not intended to limit the invention to the form disclosed herein. Consequently, variations and modifications commensurate with the above teachings, and skill and knowledge of the relevant art, are within the scope of the invention. The embodiments described hereinabove are further intended to explain best modes known of practicing the invention and to enable others skilled in the art to utilize the invention in such, or other embodiments and with various modifications required by the particular application(s) or use(s) of the invention. It is intended that the appended claims be construed to include alternative embodiments to the extent permitted by the prior

What is claimed is:

1. A packaged gum product, comprising:
a plurality of gum pellets, each pellet having a region of gum material and an outer shell of material that is relatively harder than the gum material, the region of gum material forming an inner void that contains liquid material; and
a package that contains the plurality of gum pellets, the package having a plurality of separate compartments formed as cavities therein, each of the compartments being sealed off from the exterior by a layer of foil having a thickness of 18 microns or less, to facilitate each compartment being selectably opened by pushing the liquid-filled gum pellets through the foil layer without cracking the outer shell of the liquid-filled gum pellet.

2. A packaged gum product as defined in claim 1, wherein the separate compartments are composed of a transparent material to allow the contained gum pellets to be visible from the exterior of the package.

3. A packaged gum product as defined in claim 1, wherein the portion of the package that defines separate compartments is composed of a plastic material.

4. A packaged gum product as defined in claim 3, wherein the plastic material is PVC.

5. A packaged gum product as defined in claim 1, wherein there is a one-to-one correspondence between the number of gum pellets in the package and the number of separate compartments formed in the package.

6. A packaged gum product as defined in claim 1, wherein a single sheet of foil seals all of the compartments.

7. A packaged gum product as defined in claim 1, wherein the separate compartments are formed in a single plane.

8. A packaged gum product as defined in claim 1, wherein the layer of foil has a thickness of approximately 16 microns.

9. A method of providing gum product, comprising:
providing a plurality of gum pellets, each pellet having a region of gum material and an outer shell of material that is relatively harder than the gum material, the region of gum material forming an inner void that contains liquid material;
providing a package that contains the plurality of gum pellets, the package having a plurality of separate compartments formed as cavities therein, each of the compartments being sealed off from the exterior by a layer of foil having a thickness of 18 microns or less; and
dispensing gum pellets from the package by pushing the liquid-filled gum pellets through the foil layer without cracking the outer shell of the liquid-filled gum pellet.

10. A method as defined in claim 9, wherein the separate compartments are composed of a transparent material to allow the contained gum pellets to be visible from the exterior of the package.

11. A method as defined in claim 9, wherein the portion of the package that defines separate compartments is composed of a plastic material.

12. A method as defined in claim 11, wherein the plastic material is PVC.

13. A method as defined in claim 9, wherein there is a one-to-one correspondence between the number of gum pellets in the package and the number of separate compartments formed in the package.

14. A method as defined in claim 9, wherein a single sheet of foil seals all of the compartments.

15. A method as defined in claim 9, wherein the separate compartments are formed in a single plane.

16. A method as defined in claim 9, wherein the layer of foil has a thickness of approximately 16 microns.

17. A method of providing gum product, comprising:
providing a plurality of gum pellets, each pellet having a region of gum material and an outer shell of material that is relatively harder than the gum material, the region of gum material forming an inner void that contains liquid material;
providing a package that contains the plurality of gum pellets, the package having a plurality of separate compartments formed as cavities therein, each of the compartments being sealed off from the exterior by a layer of foil having a thickness of 18 microns or less to facilitate the dispensing of gum pellets from the package by pushing the liquid-filled gum pellets through the foil layer without cracking the outer shell of the liquid-filled gum pellet.

18. A method as defined in claim 17, wherein there is a one-to-one correspondence between the number of gum pellets in the package and the number of separate compartments formed in the package.

19. A method as defined in claim 17, wherein the separate compartments are formed in a single plane.

20. A method as defined in claim 17, wherein the layer of foil has a thickness of approximately 16 microns.
